(19) United States
(12) Patent Application Publication
(10) Pub. No.: US 2006/0271771 A1
(43) Pub. Date: Nov. 30, 2006

(54) Exception tagging

(75) Inventors: Tristan H. Cartony, Fargo, ND (US); Derek S. Barka, Litchfield, NH (US)

Correspondence Address: WESTMAN CHAMPLIN (MICROSOFT CORPORATION), SUITE 1400, 900 SECOND AVENUE SOUTH, MINNEAPOLIS, MN, 55402-3319, US

(73) Assignee: Microsoft Corporation, Redmond, WA (US)

(21) Appl. No.: 11/141,302

(22) Filed: May 31, 2005

(51) Int. Cl. G06F 9/44

(52) U.S. Cl. 712/244

(57) ABSTRACT

Tagging of exceptions is disclosed. An apparatus for tagging exceptions includes a processor adapted to execute program code instructions. Memory is coupled to the processor and contains program code. The processor is configured to generate an exception object when an abnormal condition occurs with respect to execution of at least one of the program code instructions. The processor then sets a unique identifier relative to the object related to the at least one of the program code instruction. A method and data structure for tagging exceptions are also provided.

### BACKGROUND OF THE INVENTION

In the past twenty five years or so computers have become more and more ubiquitous and important in everyday life. As computing technology has advanced, the relative cost for obtaining such technology has essentially dropped. The result of this is that over the years more and more consumers now have access to more powerful computing devices.

In order to make effective use of a given computing device, it is important to have software that functions effectively on the computing device. As the state of the art of computers has advanced, software systems have become more complex. A given modern-day software system may employ hundreds of thousands of lines of code in various modules calling each other and/or external modules on the local machine or even on other machines located remotely across a network, or even across the internet. One difficulty with the enormous complexity of modern-day software systems is that should an abnormal condition occur, it is important that the ultimate cause of the abnormal condition be found such that a developer or software technician can take remedial action. Given that the actual cause of the software system may be generated by an abnormal condition with respect to a single line of code among hundreds of thousands of lines of code, identification of the cause is often extremely difficult.

Modern-day computing systems address this difficulty by generating an exception when such a condition is encountered. An exception is any error, condition or unexpected behavior encountered by an executing program. Exceptions can be raised because of a fault in program code, or in code called by program code (such as a shared library), unavailable operating resources, unexpected conditions, run-time engine encounters, and so on. It is important for an application to recover from some of these conditions, but not others. While recovery from most application exceptions can be achieved, it is impossible to recover from many run time exceptions.

In Microsoft's.Net Framework system, there is a system exception class known as system.exception. When an exception is generated, or “thrown” an object of this class is instantiated to represent the exception. The exception class has several properties that make understanding the exception easier. These properties include: a StackTrace property that can sometimes be used to determine where an error occurred; an InnerException property that can be used to create and preserve a series of exceptions during exception handling; a message property that provides details about the cause of the exception; and a HelpLink property that can hold a URL to a help file that provides more information about the exception. The StackTrace property includes the name of the source file and the program line number if debugging information is available. Typically, the StackTrace is captured immediately before an exception object is thrown.

Capturing the StackTrace provides an important piece of exception handling information related to the call stack. The call stack is essentially textual data that has the name of each method called. When an exception is thrown, the call stack as it exists at the time of the exception is associated with the exception object. This essentially creates a snapshot of the run-time call stack as it appeared at the time of the exception.

One potential limitation of prior art exception handling systems is that during typical exception handling, once an exception has been thrown and control has moved further up the call stack, it becomes difficult to accurately determine where the exception originated. A developer can use a call stack associated with the exception to pinpoint where the exception started, but this mechanism is not guaranteed to return an accurate result. This is particularly so because the call stack may not, in fact, be correct. For example, code somewhere in the unwind stack (an ordered list of potential handlers for the exception object) may catch the exception and then throw it again, the byproduct of which is an entirely new call stack being associated with the new exception. This situation hides, or otherwise obscures, the origin of the original exception. Once this has occurred, there is no way to retrieve the originating location of the exception; it is effectively lost to the application.

Additionally, even in the case where an accurate call stack may be retrieved, the call stack may only contain method call information. Depending on the size of the code of a method, many exceptions may be thrown in multiple places inside the method. Thus, even knowing the method name is not always sufficient to know the origination of an exception. In other words, a call stack associated with an exception does not have a high enough degree of fidelity with respect to the exception's origin.

The inability to reliably track, to the source code line level, where an exception originates creates a time-consuming impediment to building more robust software.

### SUMMARY OF THE INVENTION

Tagging of exceptions is disclosed. An apparatus for tagging exceptions includes a processor adapted to execute program code instructions. Memory is coupled to the processor and contains program code. The processor is configured to generate an exception object when an abnormal condition occurs with respect to execution of at least one of the program code instructions. The processor then sets a unique identifier relative to the object related to the at least one of the program code instruction. A method and data structure for tagging exceptions are also provided.

### BRIEF DESCRIPTION OF THE DRAWINGS

FIG. 1 is a block diagram of one computing environment in which the present invention may be practiced.

FIG. 2 is a block diagram of an alternative computing environment in which the present invention may be practiced.

FIG. 3 is a diagrammatic view of an exception being thrown in accordance with an embodiment of the present invention.

### DETAILED DESCRIPTION OF ILLUSTRATIVE EMBODIMENTS

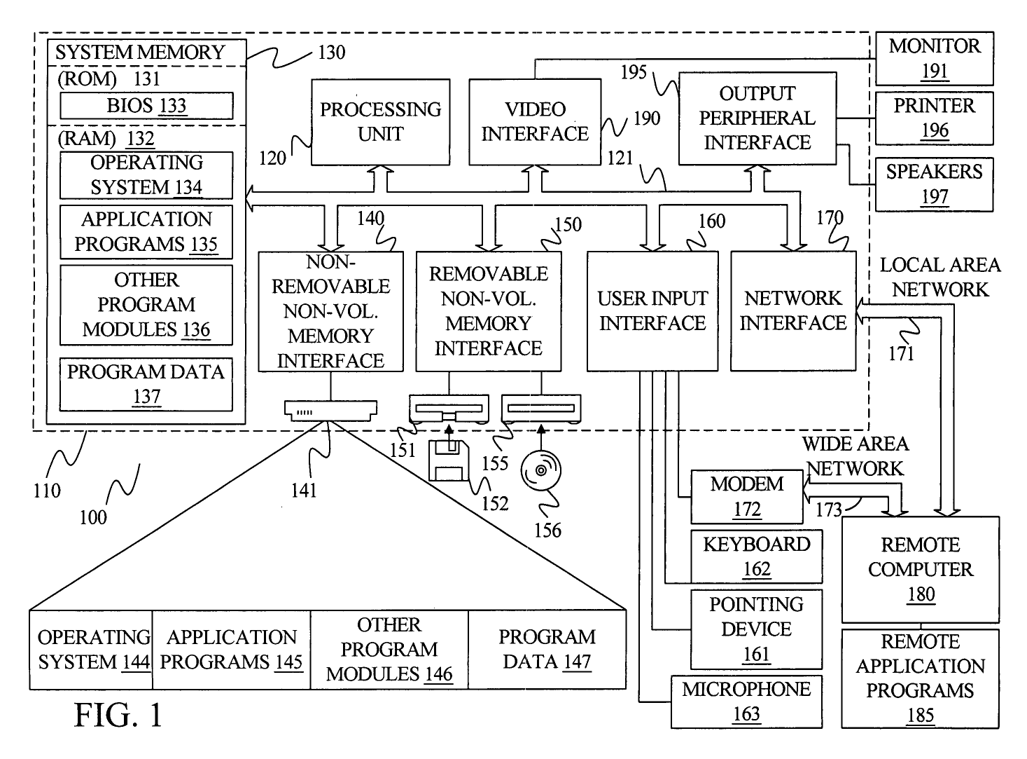

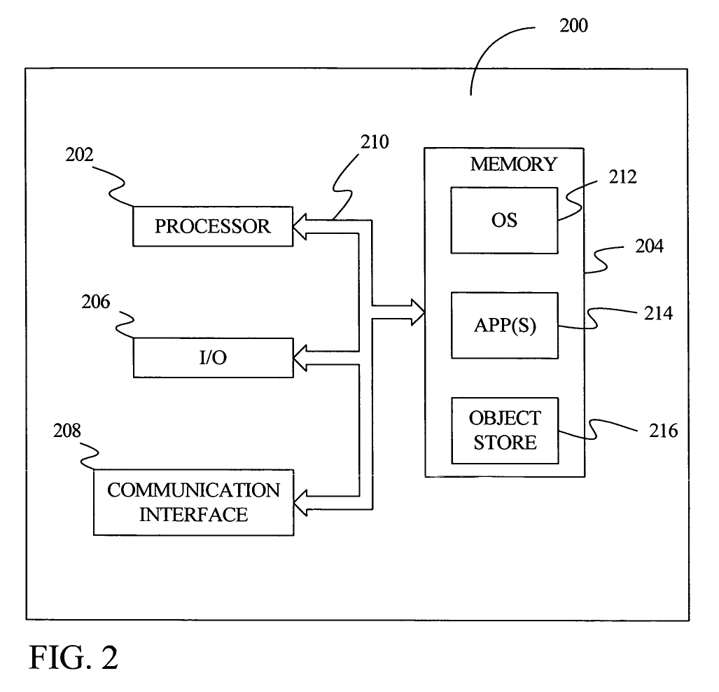

Embodiments of the present invention are applicable to any computing device or environment where program or application code is executed. Before describing particular embodiments of the present invention, a couple of exemplary computing devices will be described for which embodiments of the present invention are particularly useful. While the description of FIGS. 1 and 2 are directed to single computing devices, it is expressly contemplated that embodiments of the present invention are practicable for computing environments that employ a number of such devices.

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well-known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention is designed to be practiced in distributed computing environments where tasks are performed by remote processing devices that are linked through a communications network. In a distributed computing environment, program modules are located in both local and remote computer storage media including memory storage devices.

With reference to FIG. 1, an exemplary system for implementing the invention includes a general-purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, a program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 is operated in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

FIG. 2 is a block diagram of a mobile device 200, which is an exemplary computing environment. Mobile device 200 includes a microprocessor 202, memory 204, input/output (I/O) components 206, and a communication interface 208 for communicating with remote computers or other mobile devices. In one embodiment, the afore-mentioned components are coupled for communication with one another over a suitable bus 210.

Memory 204 is implemented as non-volatile electronic memory such as random access memory (RAM) with a battery back-up module (not shown) such that information stored in memory 204 is not lost when the general power to mobile device 200 is shut down. A portion of memory 204 is preferably allocated as addressable memory for program execution, while another portion of memory 204 is preferably used for storage, such as to simulate storage on a disk drive.

Memory 204 includes an operating system 212, application programs 214 as well as an object store 216. During operation, operating system 212 is preferably executed by processor 202 from memory 204. Operating system 212, in one preferred embodiment, is a WINDOWS® CE brand operating system commercially available from Microsoft Corporation. Operating system 212 is preferably designed for mobile devices, and implements database features that can be utilized by applications 214 through a set of exposed application programming interfaces and methods. The objects in object store 216 are maintained by applications 214 and operating system 212, at least partially in response to calls to the exposed application programming interfaces and methods.

Communication interface 208 represents numerous devices and technologies that allow mobile device 200 to send and receive information. The devices include wired and wireless modems, satellite receivers and broadcast tuners to name a few. Mobile device 200 can also be directly connected to a computer to exchange data therewith. In such cases, communication interface 208 can be an infrared transceiver or a serial or parallel communication connection, all of which are capable of transmitting streaming information.

Input/output components 206 include a variety of input devices such as a touch-sensitive screen, buttons, rollers, and a microphone as well as a variety of output devices including an audio generator, a vibrating device, and a display. The devices listed above are by way of example and need not all be present on mobile device 200. In addition, other input/output devices may be attached to or found with mobile device 200 within the scope of the present invention.

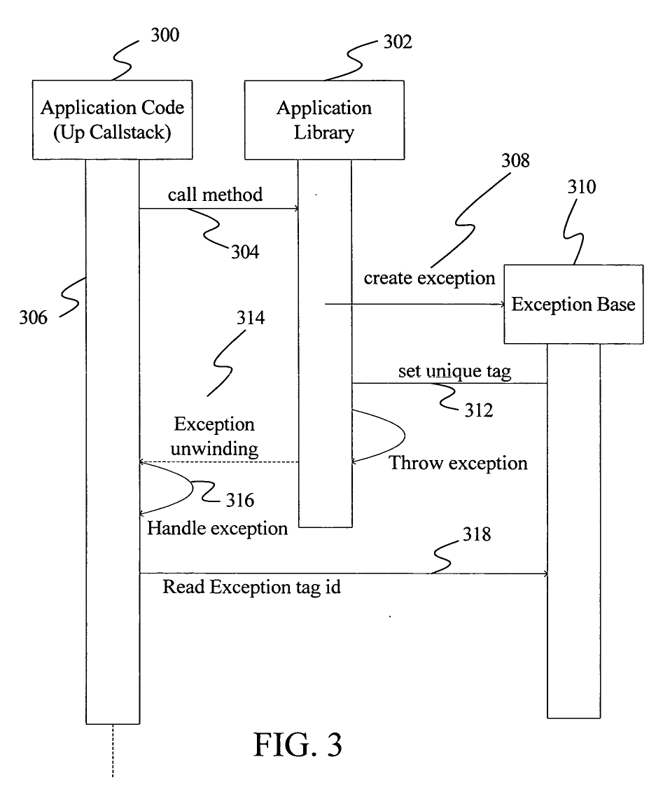

FIG. 3 is a diagrammatic view of an exception being thrown in accordance with an embodiment of the present invention. FIG. 3 illustrates an application having application code 300 running on a computing device such as those described above with respect to FIGS. 1 and 2, or within a computing environment. As the application runs, a call is made to application library as indicated by line 304. Call stack 306 maintains information relative to the exact line of code that generated method call 304. The call results in an abnormal condition wherein the computing device is unstable, or could become unstable if the call is processed normally. Thus, the computing device creates an exception as indicated at line 308. Once the exception is created, exception base class 310 is used to create an object that represents the exception. At this point, a snapshot of the current environment is taking by associating the current call stack with the exception object.

In accordance with an embodiment of the present invention, a unique identifier is set within the exception object. This unique identifier is preferably indicative of at least the line of code 300 that was last attempted to be executed before the exception was created. For some purposes, the placement of this information within the exception object may seem duplicative, since the call stack associated with the exception may be able to provide information about the code line number that caused the exception. However, modern exception handling systems have various levels of exception handling. Software designers are able to employ structured exception handling to specify types of exceptions that can be handled by their code. Moreover, they can create exception handling routines that catch an exception, add data to it, and throw it again. While this is helpful for many situations, it effectively loses the original call stack information, since the second throw will associate a call stack having different states with the rethrown exception, thereby decreasing fidelity.

The provision of a unique identifier, such as a globally unique identifier (GUID) within the exception object allows the original exception information to be maintained even in cases where custom exception handling routines catch and rethrow the exception; wrap it; or otherwise modify it.

Once the unique identifier has been set as illustrated at line 312 in FIG. 3, the exception is actually thrown. This means that the exception object has been instantiated, and an “unwind” stack is used to step through a programmatic hierarchy of potential exception handler routines or modules until a handler is found that matches the type of exception thrown. This exception handling is illustrated diagrammatically at reference numerals 314 and 316 which illustrate unwinding and handling, respectively. The exception handler can, in accordance with embodiments of the present invention, consult the unique identifier information and report the line number of the code that generated the exception. Reading of the unique identifier is illustrated at line 318.

Providing the ability to tag an exception, in accordance with embodiments of the present invention, can be accomplished in different ways. First, a base extension class can be created that includes a unique identifier property and has the ability to wrap objects of an non-exception tagging exception class. Another way to accommodate the tagging of exceptions is to employ a derivative exception class that inherits from a standard exception class, such as System.Exception. This derivative exception class includes a unique identifer property. Preferably, the unique identifier property is an exposed public property and is read-only. This enhanced exception class can be used throughout the application code and application code may even extend it to create new, unique exception types. Preferably, the GUID parameter of the constructor is used to set the initial value of the unique identifier.

While embodiments of the present invention have described providing a unique identifier to the exception based on the program line last attempted to be executed, it is contemplated that the unique identifier can be a combination of that data and other useful data, such as the exception type.

Embodiments of present invention generally provide a robust exception tracking and handling architecture. Moreover, current exception classes and objects can be leveraged and employed such that much of the mechanics of actual exception handling need not change. However, system programmers and support technicians will now have more reliable exception information at their disposal and will be better able to quickly understand the cause of a given exception. It is believed that this will save time in the generation and testing of more robust program code.

Although the present invention has been described with reference to particular embodiments, workers skilled in the art will recognize that changes may be made in form and detail without departing from the spirit and scope of the invention.

What is claimed is:

1. A computing device comprising:
a processor adapted to execute program code instructions;
memory coupled to the processor and having program code instructions therein; and
wherein the processor is configured to generate an exception object when an abnormal condition occurs with respect to execution of at least one of the program code instructions, and wherein the processor is further configured to set a unique identifier relative to the object related to the at least one of the program code instruction.

2. The computing device of claim 1, wherein the unique identifier is indicative of the program code instruction.

3. The computing device of claim 1, wherein the unique identifier is a globally unique identifier.

4. The computing device of claim 1, wherein the object is a member of an exception class.

5. The computing device of claim 4, wherein the exception class inherits from System.Exception class.

6. The computing device of claim 4, wherein the exception class is configured to wrap an object of a non-exception tagging exception class.

7. The computing device of claim 1, wherein the unique identifier is a property of the object.

8. The computing device of claim 7, wherein the unique identifier property is a public property.

9. A method of generating an exception in a computing device, the method comprising:
receiving an indication that attempted execution of a current program instruction has resulted in an abnormal condition;
instantiating an exception object to maintain information relative to the exception;
setting a unique identifier property relative to the exception object; and
throwing the exception object.

10. The computing device of claim 9, wherein the unique identifier is indicative of the program code instruction.

11. The computing device of claim 9, wherein the unique identifier is a globally unique identifier.

12. The computing device of claim 9, wherein the object is a member of an exception class.

13. The computing device of claim 12, wherein the exception class inherits from System.Exception class.

14. The computing device of claim 12, wherein the exception class is configured to wrap an object of a non-exception tagging exception class.

15. The computing device of claim 9, wherein the unique identifier is a property of the object.

16. The computing device of claim 15, wherein the unique identifier property is a public property.

17. A computer-readable medium having stored thereon a data structure indicative of an exception, said data structure comprising:
a first property field storing a unique identifier with respect to the exception; and
wherein the data structure represents an object of an exception class.

18. The computer-readable medium of claim 17, wherein the data structure is configured to wrap an object of a non-tagging exception class.

19. The computer readable medium of claim 17, wherein the exception class inherits from a non-tagging exception class.

20. The computer-readable medium of claim 17, wherein the first property field is a public property field.
